(19) United States
(12) Patent Application Publication
(10) Pub. No.: US 2002/0083179 A1
(43) Pub. Date: Jun. 27, 2002

(54) System and method of personalizing communication sessions based on user behavior

(76) Inventors: Venson M . Shaw, Plano, TX (US); Mark W. Carde, Denton, TX (US)

Correspondence Address: MUNSCH, HARDT, KOPF & HARR, P.C., INTELLECTUAL PROPERTY DOCKET CLERK, 1445 ROSS AVENUE, SUITE 4000, DALLAS, TX, 75202-2790, US

(21) Appl. No.: 09/746,396

(22) Filed: Dec. 21, 2000

Related U.S. Application Data
(60) Provisional application No. 60/203,761, filed on May 12, 2000.

(51) Int. Cl. G06F 15/16; G06F 15/173; G06F 19/00; G06F 17/00; A63F 13/00; A63F 9/24

(52) U.S. Cl. 709/227; 463/1

(57) ABSTRACT

In an embodiment of the present invention, an interactive behavior-based communication system includes a behavior monitor operable to detect specific behavior and actions of a user during a communication session, a behavior matching engine operable to receive the detected user behavior and actions, match them to predetermined and defined behaviors and actions, and determine an appropriate dynamic response in response to a match, and a content database storing content presentable to the user to dynamically modify the communication session in response to the determined response.

### BACKGROUND OF THE INVENTION

Broadband technology brings the capability and possibility of more bandwidth, more interactivity, and better applications that can take advantage of the technology. However, without a clear understanding of the end user experience, it is extremely tedious and inefficient to allow the end user to browse the applications menu, select the desirable applications, and select the options and features within the application to tailor it to his/her preferences or capabilities.

Currently, the available technology provides a user profile form for the end user to fill out typically at registration. The user profile generally asks for profile information such as name, sex, age, address, email address, etc. and further asks about user preferences, such as language preference, application preference, news and current events preference, etc. The disadvantage of these types of Q-and-A user profiles is that the information is collected based on the users' own perceived preferences. This technology does not collect information based on actual end user usage or real time behavior. Furthermore, the number of questions cannot be too voluminous because users have a limited amount of time and patience to respond to this type of questionnaires. Therefore, the user profile is not capable of gathering a wide scope or detailed information from the users, and the resultant customization leaves much to be desired.

### SUMMARY OF THE INVENTION

In accordance with the present invention, real-time user behavior and activity data is collected as the user uses certain applications or during certain communication sessions. The applications or communication sessions are then personalized in real-time according to the collected behavior and activity data to make the applications or communication sessions behave in a customized manner to enhance the user's experience. The user may be presented with advice to improve his/her online performance. The session, if an e-game session, may be made more challenging or less challenging depending on the observed skill level of the user. Targeted advertising and marketing material may be presented to the user, which may be a source of revenue for the game portal.

In an embodiment of the present invention, an interactive behavior-based communication system includes a behavior monitor operable to detect specific behavior and actions of a user during a communication session, a behavior matching engine operable to receive the detected user behavior and actions, match them to predetermined and defined behaviors and actions, and determine an appropriate dynamic response in response to a match, and a content database storing content presentable to the user to dynamically modify the communication session in response to the determined response.

In another embodiment of the present invention, an interactive behavior-based e-game system includes a behavior monitor operable to detect specific behavior and actions of a player during an e-game session, a behavior matching engine operable to receive the detected player behavior and actions, match them to predetermined and defined behaviors and actions, and determine an appropriate dynamic response in response to a match, a player profile database operable to receive and store the detected specific behavior and action, and a content database storing content presentable to the player to dynamically modify the e-game session in response to the determined response.

In yet another embodiment of the present invention, an interactive behavior-based method of personalizing an online session includes the steps of monitoring and detect a user's behavior and actions during the online session, comparing the detected user's behavior and actions to predetermined behaviors and actions, identifying an appropriate action in response to a match between the detected user's behavior and actions to predetermined behaviors and actions, and carrying out the appropriate action to dynamically modify the online session.

In yet another embodiment of the present invention, an interactive dynamic behavior-based method of personalizing an e-game session includes the steps of monitoring and detect a player's behavior and actions during the e-game session, comparing the detected user's behavior and actions to predetermined behaviors and actions, and dynamically altering at least one aspect of the e-game session in response to a match between the detected player's behavior and actions to the predetermined behaviors and actions.

In yet another embodiment of the present invention, an interactive dynamic behavior-based method of personalizing an e-game session includes the steps of receiving detected player behavior and actions during the e-game session, comparing the detected player behavior and actions to predetermined behaviors and actions, and sending data to the player operable to dynamically alter at least one aspect of the e-game session in response to a match between the detected player behavior and actions to the predetermined behaviors and actions.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 is a simplified block and data flow diagram of an embodiment of the system and method of personalizing communication sessions based on user behavior according to the teachings of the present invention;

FIG. 2 is a more detailed block and data flow diagram of an embodiment of the system and method of personalizing communication sessions based on user behavior according to the teachings of the present invention;

FIG. 3 is a state transition diagram during initiation of an embodiment of the system and method of personalizing communication sessions based on user behavior according to the teachings of the present invention; and

FIG. 4 is a state transition diagram during an on-going communication session of an embodiment of the system and method of personalizing communication sessions based on user behavior according to the teachings of the present invention.

### DETAILED DESCRIPTION OF THE DRAWINGS

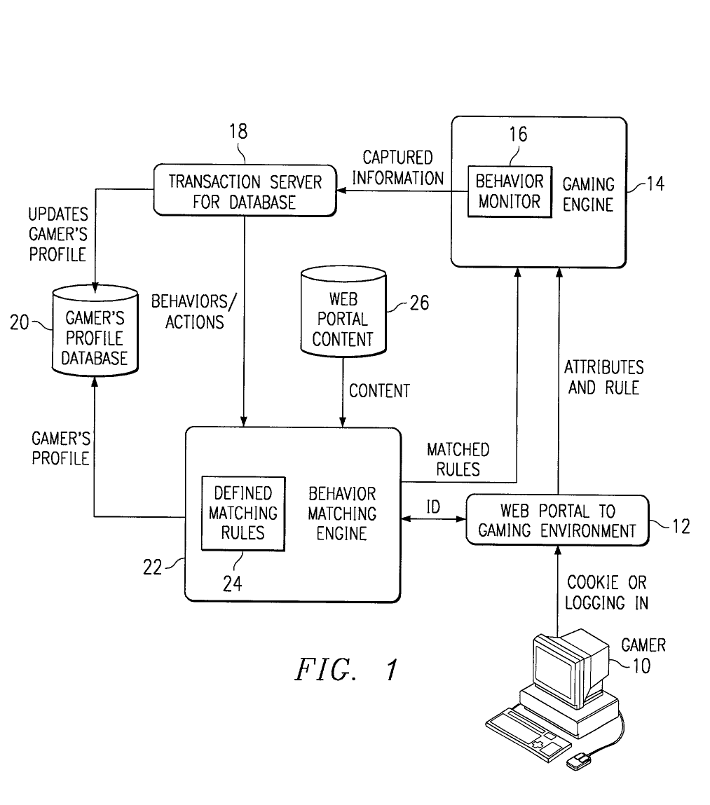

The preferred embodiment of the present invention and its advantages are best understood by referring to FIGS. 1 through 4 of the drawings, like numerals being used for like and corresponding parts of the various drawings.

FIG. 1 is a simplified block and data flow diagram of an embodiment of the system and method of personalizing communication sessions based on user behavior according to the teachings of the present invention. A user 10 registers and logs onto a web portal 12 to select and play a game or initiate an interactive communication or online session. The user 10 can also be identified when he enters a portal by cookies. Web portal 12 passes appropriate communication session attributes and rules to a gaming engine or server 14 to set up the session. An application engine or gaming engine 14 includes a behavior monitor 16, which monitors the end user's behavior or activities during a communication or gaming session. Communication session or gaming session is herein defined as any online session over the computer network in which one or more users enter input based on displayed content, and content is in turn displayed based on user input. Behavior monitor 16 may detect and record how the user plays or behaves in an interactive communication session or game, such as the user's movement input, type of weapon, hand-and-eye coordination, aiming accuracy, reaction time, skill level, aggressiveness, etc. Behavior monitor 16 reports the detected user behavior and reports it to a transaction server 18. Transaction server 18 passes the behavior information to a profile database 20 for storage, and further passes the behavior information in real-time to a behavior matching engine 22. Web portal 12 also transmits the user's identifying data to behavior matching engine 22. Rules 24 defined in behavior matching engine 22 compare the detected user behavior with behavior defined in the rules. The defined rules has corresponding responses associated therewith, which are transmitted to gaming engine 14 in real time. The response may include an alteration or a modification of the communication or game session to tailor it to the user's behavior. For example, the game play may be slowed down or made less challenging for an unskilled user, or speeded up or made more challenging for a skilled user. The response also may include suggestions or training tips displayed on the user's computer screen to help the user improve his/her performance and make the session more satisfying. In other words, the communication session in which the user is engaged can be dynamically modified or personalized according to the user's real-time behavior. The responses may also include content obtained from a web portal content database 26 that is then presented or displayed to the user. The content may be targeted advertising and marketing material for goods and services, or educational and training material related to the communication session. Therefore, the response may include content ancillary to the on-going communication session.

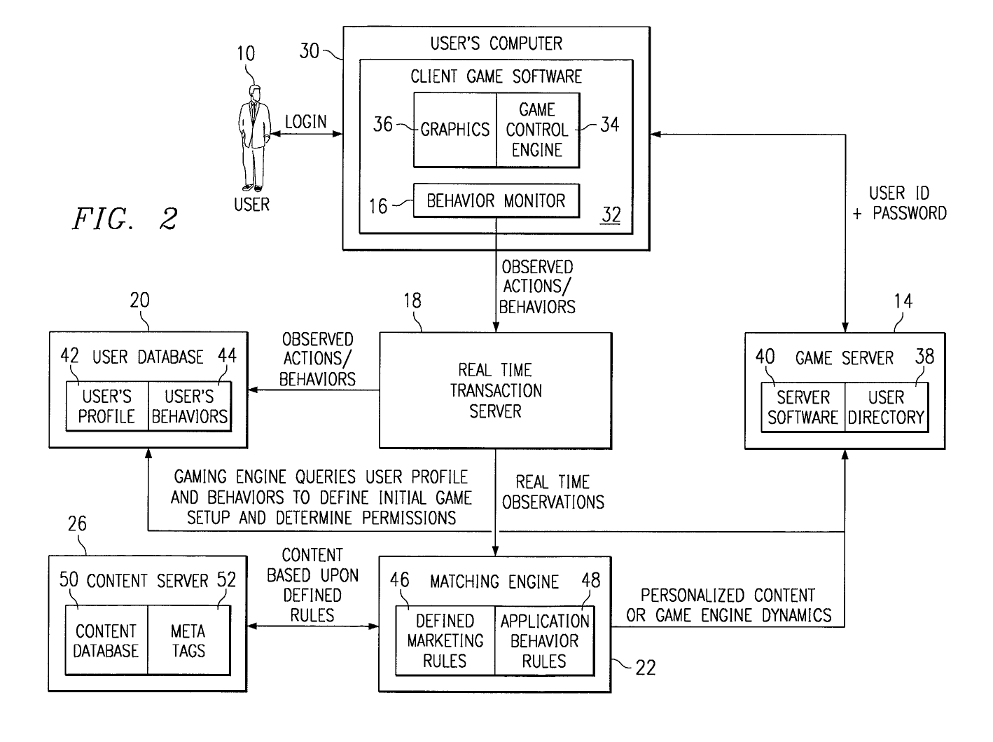

FIG. 2 is a more detailed block and data flow diagram of an embodiment of the system and method of personalizing communication sessions based on user behavior according to the teachings of the present invention. A client game software 32 resides on the user's computer 30 and provides the user access to game server 14. Game server 14 includes a user directory 38 and server software 40. Within game software 32, in addition to graphics 36 and game control engine 34, there is a behavior monitor 16 that monitors for specific behavior and activities during a communication session or game playing session, and reports the observed behavior and activities to transaction server 18. Transaction server 18 primarily performs the function of passing observed behaviors and actions to behavior matching engine 22 for rule matching and to user profile database 20 for data storage and update. User profile database 20 includes user's profile 42 (name, sex, age, address, email address, phone number, etc.) and any observed user's behavior 44. The stored user behavior may be used to setup and initiate future online sessions. It is contemplated that even if a user has never used a certain online application, that online application's behavior can be initiated or modified the first time the user uses it based on the user's past observed and stored behavior. Behavior matching engine 22 receives the observed behavior and actions and matches them against predefined behaviors and actions defined in the rules. The rules may include defined marketing rules 46 for real-time delivery of ancillary content and application behavior rules 48 for effecting real-time application modification and personalization. Content server 26 includes a content database 50 and meta tags 52. Meta tags 52 provide a searchable index to access the content whenever a matched rule suggests a response stored in content database 50. The data stored in content database 50 may include material or information that is displayable on the user's screen or instructional code that would modify the communication session or the user's game play experience.

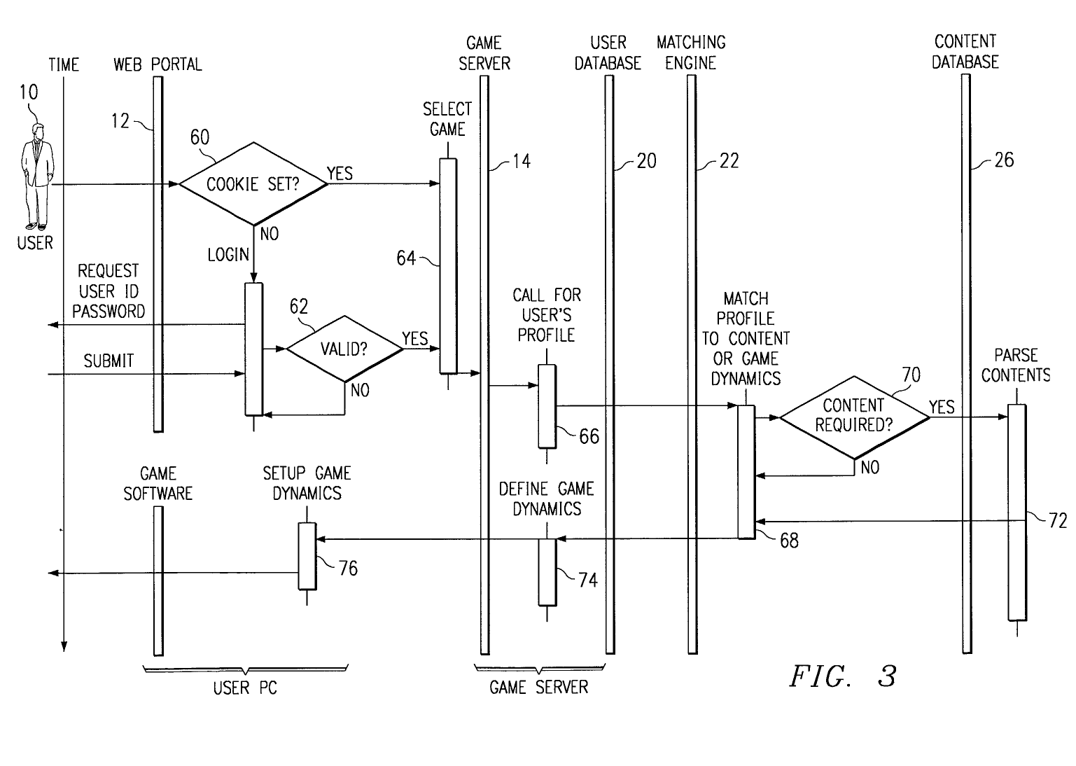

FIG. 3 is a state transition diagram during initiation of an embodiment of the system and method of personalizing communication sessions based on user behavior according to the teachings of the present invention. User 10 navigates to web portal 12 and is identified by a previously set cookie (block 60) or by registration/logging in (block 63). The registration may include a request that the user fill out a questionnaire or form requesting the user's personal data and preferences. User 10 selects an application or a game that he/she desires to participate in (block 64), and is connected to game server 14. Upon identifying the user, the game server then call for the user profile from user profile database 20, which is compared and matched to defined rules in behavior matching engine 22 (block 68). Based on the defined rules, the game dynamics are then set up based on the user's stored preferences and the stored behavior/action form previous sessions. If behavior matching engine 22 determines, based on the defined rules, that certain content needs to be presented to user 10 (block 70), the content is parsed from content database 26 and delivered during the session to the user. Similarly, the game dynamics can be set up and altered based on the defined rules (blocks 74 and 76) on the user's computer.

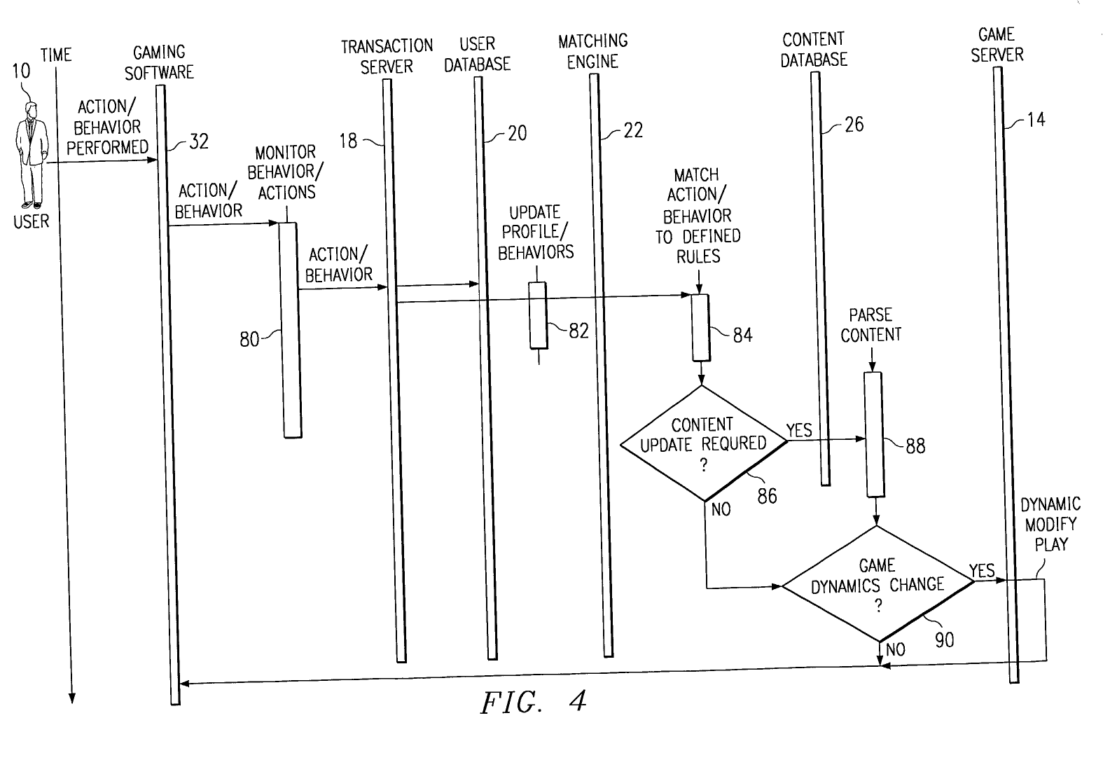

FIG. 4 is a state transition diagram during an on-going communication session of an embodiment of the system and method of personalizing communication sessions based on user behavior according to the teachings of the present invention. User 10 is already engaged in an online session and had previously logged onto game server 14 and the user's identity and profile are thus known. When user 10 performs an action, such as movement which has directional and speed components, or demonstrates a behavior that has significance in the online session, it is observed by behavior monitor 16 (block 80). Behavior monitor passes this observation onto transaction server 18, which is responsible for storing the information in user's profile database 20 (block 82) and also passing the information to behavior matching engine 22. Behavior matching engine 22 matches the observed action or behavior to a set of known actions and behaviors that have defined rules associated therewith (block 84). Behavior matching engine 22, after determining the system response to an observed user behavior or action, either calls for content to be presented to the user during the session (blocks 86 and 88), sends a command to change the game dynamics (blocks 86 and 90), or does both or nothing, based on the defined rules. The presented content or changed session dynamics together enhance the overall user experience and enable targeted and more relevant advertising and marketing materials to be displayed. Although the present invention has been described in the context of Internet-based online gaming or communication sessions, the technology is equally applicable to localized systems.

The extracted user behavior, due to the common nature of the game, causes the users to become more emotionally involved, and therefore, the behaviors can be easily exposed. The extracted behavior can be further generalized to facilitate future application sessions. Also, this method allows businesses and marketing agencies to target advertising materials during an online session based upon an individual's behavior and actions. The game engine may also alter game play to make it more satisfying and conforming to the end user behavior and expectations. Streaming personalized advertising can be inserted during the session. An embodiment of the present invention utilizes neural nets to determine and extract user behavior.

The use of terminology such as “server”, “engine”, and “database” in the description is not intended to limit the embodiment and implementation of the present invention. All components may be hardware, software, firmware, programmable logic, and combinations thereof. Furthermore, the location of the components is not limited specifically to that shown in the drawing figures.

While the invention has been particularly shown and described by the foregoing detailed description, it will be understood by those skilled in the art that various changes, alterations, modifications, mutations and derivations in form and detail may be made without departing from the spirit and scope of the invention.

What is claimed is:

1. An interactive behavior-based communication system, comprising:
a behavior monitor operable to detect specific behavior and actions of a user during a communication session;
a behavior matching engine operable to receive the detected user behavior and actions, match them to predetermined and defined behaviors and actions, and determine an appropriate dynamic response in response to a match; and
a content database storing content presentable to the user to dynamically modify the communication session in response to the determined response.

2. The system, as set forth in claim 1, further comprising a transaction server operable to receive the detected specific behavior and action from the behavior monitor and to pass them to the behavior matching engine.

3. The system, as set forth in claim 2, further comprising a user profile database operable to receive and store the detected specific behavior and action from the transaction server.

4. The system, as set forth in claim 2, further comprising a user profile database operable to receive and store user profile data received at user registration.

5. The system, as set forth in claim 1, wherein the behavior matching engine comprises:
a first set of rules defining ancillary content to be displayed to the user in response to a matched behavior; and
a second set of rules defining how the communication session is to be modified in response to a matched behavior.

6. The system, as set forth in claim 5, wherein the first set of rules comprises rules identifying targeted advertising and marketing material stored in the content server to be displayed to the user.

7. The system, as set forth in claim 5, wherein the second set of rules comprises rules identifying instructional code to modify the communication session in response to the matched user behavior and action.

8. The system, as set forth in claim 5, wherein the communication session is an e-game session and the second set of rules comprises rules identifying instructional code to dynamically make the communication session more challenging in response to detecting that the user is a skilled game player.

9. The system, as set forth in claim 5, wherein the communication session is an e-game session and the second set of rules comprises rules identifying instructional code to dynamically make the communication session less challenging in response to detecting that the user is a skilled game player.

10. The system, as set forth in claim 5, wherein the communication session is an e-game session and the second set of rules comprises rules identifying instructional code to dynamically tailor the communication session to the detected user's style of game playing.

11. The system, as set forth in claim 5, wherein the communication session is an e-game session and the second set of rules comprises rules identifying instructional code to dynamically tailor the communication session to the detected user's skill in playing a particular online game.

12. The system, as set forth in claim 1, wherein the behavior monitor resides in a computer being used by the user to execute an application associated with the communication session, the behavior monitor transmitting the detected user behavior and action to the behavior matching engine.

13. The system, as set forth in claim 1, wherein the behavior monitor resides in a game server providing a portal to the user, the behavior monitor transmitting the detected user behavior and action to the behavior matching engine.

14. The system, as set forth in claim 2, wherein the user behavior and action stored in the user profile database is accessed to dynamically enhance a currently on-going communication session.

15. The system, as set forth in claim 2, wherein the user behavior and action stored in the user profile database is accessed to dynamically enhance a future communication session involving the same user and same application in which the user behavior and action are detected.

16. The system, as set forth in claim 2, wherein the user behavior and action stored in the user profile database is accessed to dynamically enhance a future communication session involving the same user and a different application than one in which the user behavior and action are detected.

17. An interactive behavior-based e-game system, comprising:
a behavior monitor operable to detect specific behavior and actions of a player during an e-game session;
a behavior matching engine operable to receive the detected player behavior and actions, match them to predetermined and defined behaviors and actions, and determine an appropriate dynamic response in response to a match;
a player profile database operable to receive and store the detected specific behavior and action; and
a content database storing content presentable to the player to dynamically modify the e-game session in response to the determined response.

18. The system, as set forth in claim 17, further comprising a transaction server operable to receive the detected specific behavior and action from the behavior monitor and to pass them to the behavior matching engine.

19. The system, as set forth in claim 17, wherein the player profile database is further operable to receive and store player profile data received at player registration.

20. The system, as set forth in claim 17, wherein the behavior matching engine comprises:
a first set of rules defining ancillary content to be displayed to the player in response to a matched behavior; and
a second set of rules defining how the e-game session is to be modified in response to a matched behavior.

21. The system, as set forth in claim 20, wherein the first set of rules comprises rules identifying targeted advertising and marketing material stored in the content server to be displayed to the player.

22. The system, as set forth in claim 20, wherein the second set of rules comprises rules identifying instructional code to modify the e-game session in response to the matched player behavior and action.

23. The system, as set forth in claim 20, wherein the second set of rules comprises rules identifying instructional code to dynamically make the e-game session more challenging in response to detecting that the player is a skilled game player.

24. The system, as set forth in claim 20, wherein the second set of rules comprises rules identifying instructional code to dynamically make the e-game session less challenging in response to detecting that the player is a skilled game player.

25. The system, as set forth in claim 20, wherein the second set of rules comprises rules identifying instructional code to dynamically tailor the e-game session to the detected player's style of game playing.

26. The system, as set forth in claim 20, wherein the second set of rules comprises rules identifying instructional code to dynamically tailor the e-game session to the detected player's skill in playing a particular online game.

27. The system, as set forth in claim 17, wherein the behavior monitor resides in a computer being used by the player to execute an application associated with the e-game session, the behavior monitor transmitting the detected player behavior and action to the behavior matching engine.

28. The system, as set forth in claim 17, wherein the behavior monitor resides in a game server providing a portal to the player, the behavior monitor transmitting the detected player behavior and action to the behavior matching engine.

29. The system, as set forth in claim 17, wherein the player behavior and action stored in the player profile database is accessed to dynamically enhance a currently on-going e-game session.

30. The system, as set forth in claim 17, wherein the player behavior and action stored in the player profile database is accessed to dynamically enhance a future e-game session involving the same user and same gaming application in which the player behavior and action are detected.

31. The system, as set forth in claim 17, wherein the player behavior and action stored in the player profile database is accessed to dynamically enhance a future communication session involving the same player and a different gaming application than one in which the player behavior and action are detected.

32. An interactive behavior-based method of personalizing an online session, comprising:
monitoring and detect a user's behavior and actions during the online session;
comparing the detected user's behavior and actions to predetermined behaviors and actions;
identifying an appropriate action in response to a match between the detected user's behavior and actions to predetermined behaviors and actions; and
carrying out the appropriate action to dynamically modify the online session.

33. The method, as set forth in claim 32, further comprising storing the detected user's behavior and actions in a user profile database.

34. The method, as set forth in claim 33, further comprising:
allowing the user to register in order to initiate the online session;
collecting user profile data as part of user registration; and
storing the collected user profile in the user profile database.

35. The method, as set forth in claim 32, wherein identifying an appropriate action comprises identifying content to be presented to the user in response to a match between the detected user's behavior and actions to predetermined behaviors and actions.

36. The method, as set forth in claim 32, wherein identifying an appropriate action comprises identifying targeted advertising and marketing material to be presented to the user in response to a match between the detected user's behavior and actions to predetermined behaviors and actions.

37. The method, as set forth in claim 32, wherein identifying an appropriate action comprises identifying targeted training material to be presented to the user in response to a match between the detected user's behavior and actions to predetermined behaviors and actions.

38. The method, as set forth in claim 32, wherein identifying an appropriate action comprises identifying a property of the online session to be modified in real-time to modify the user's online experience in response to a match between the detected user's behavior and actions to predetermined behaviors and actions.

39. The method, as set forth in claim 32, wherein identifying an appropriate action comprises identifying instructional code to modify the online session in real-time to alter the user's online experience in response to a match between the detected user's behavior and actions to predetermined behaviors and actions.

40. The method, as set forth in claim 32, wherein identifying an appropriate action comprises accessing a content database for retrieving content to be presented to the user in response to a match between the detected user's behavior and actions to predetermined behaviors and actions.

41. An interactive dynamic behavior-based method of personalizing an e-game session, comprising:
monitoring and detect a player's behavior and actions during the e-game session;
comparing the detected user's behavior and actions to predetermined behaviors and actions; and
dynamically altering at least one aspect of the e-game session in response to a match between the detected player's behavior and actions to the predetermined behaviors and actions.

42. The method, as set forth in claim 41, further comprising:
identifying an appropriate action in response to a match between the detected user's behavior and actions to predetermined behaviors and actions; and
carrying out the appropriate action to dynamically modify the e-game session.

43. The method, as set forth in claim 41, further comprising storing the detected player's behavior and actions in a player profile database.

44. The method, as set forth in claim 41, further comprising:
allowing the player to register in order to initiate the e-game session;
collecting player profile data as part of player registration; and
storing the collected player profile in the player profile database.

45. The method, as set forth in claim 41, wherein identifying an appropriate action comprises identifying content to be presented to the player in response to a match between the detected player's behavior and actions to the predetermined behaviors and actions.

46. The method, as set forth in claim 41, wherein identifying an appropriate action comprises identifying targeted advertising and marketing material to be presented to the player in response to a match between the detected player's behavior and actions to predetermined behaviors and actions.

47. The method, as set forth in claim 41, wherein identifying an appropriate action comprises identifying targeted training material to be presented to the user in response to a match between the detected player's behavior and actions to predetermined behaviors and actions.

48. The method, as set forth in claim 41, wherein identifying an appropriate action comprises identifying a property of the e-game session to be modified in real-time to modify the player's online experience in response to a match between the detected player's behavior and actions to predetermined behaviors and actions.

49. The method, as set forth in claim 41, wherein identifying an appropriate action comprises identifying instructional code to modify the e-game session in real-time to alter the player's gaming experience in response to a match between the detected player's behavior and actions to predetermined behaviors and actions.

50. The method, as set forth in claim 41, wherein identifying an appropriate action comprises accessing a content database for retrieving content to be presented to the player in response to a match between the detected player's behavior and actions to predetermined behaviors and actions.

51. An interactive dynamic behavior-based method of personalizing an e-game session, comprising:
receiving detected player behavior and actions during the e-game session;
comparing the detected player behavior and actions to predetermined behaviors and actions; and
sending data to the player operable to dynamically alter at least one aspect of the e-game session in response to a match between the detected player behavior and actions to the predetermined behaviors and actions.

52. The method, as set forth in claim 51, further comprising:
identifying an appropriate action in response to a match between the detected player behavior and actions to predetermined behaviors and actions; and
carrying out the appropriate action to dynamically modify the e-game session.

53. The method, as set forth in claim 51, further comprising storing the detected player behavior and actions in a player profile database.

54. The method, as set forth in claim 51, further comprising:
allowing the player to register in order to initiate the e-game session;
collecting player profile data as part of player registration; and
storing the collected player profile in the player profile database.

55. The method, as set forth in claim 51, further comprising allowing the player to log in in order to initiate the e-game session.

56. The method, as set forth in claim 51, wherein identifying an appropriate action comprises identifying content to be presented to the player in response to a match between the detected player's behavior and actions to the predetermined behaviors and actions.

57. The method, as set forth in claim 51, wherein identifying an appropriate action comprises identifying targeted advertising and marketing material to be presented to the player in response to a match between the detected player's behavior and actions to predetermined behaviors and actions.

58. The method, as set forth in claim 51, wherein identifying an appropriate action comprises identifying targeted training material to be presented to the user in response to a match between the detected player's behavior and actions to predetermined behaviors and actions.

59. The method, as set forth in claim 51, wherein identifying an appropriate action comprises identifying a property of the e-game session to be modified in real-time to modify the player's online experience in response to a match between the detected player's behavior and actions to predetermined behaviors and actions.

60. The method, as set forth in claim 51, wherein identifying an appropriate action comprises identifying instructional code to modify the e-game session in real-time to alter the player's gaming experience in response to a match between the detected player's behavior and actions to predetermined behaviors and actions.

61. The method, as set forth in claim 51, wherein identifying an appropriate action comprises accessing a content database for retrieving content to be presented to the player in response to a match between the detected player's behavior and actions to predetermined behaviors and actions.
